(19) United States
(12) Patent Application Publication
(10) Pub. No.: US 2007/0100888 A1
(43) Pub. Date: May 3, 2007

(54) Method and apparatus for managing content file information, and recording medium storing program for performing the method

(75) Inventors: Nam-soon Kim, Suwon-si (KR); Deok-ho Kim, Seoul (KR); Ho-shin Son, Suwon-si (KR); Yun-hee Kim, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/507,469

(22) Filed: Aug. 22, 2006

(30) Foreign Application Priority Data
Nov. 2, 2005 (KR) 10-2005-0104151

(51) Int. Cl. G06F 17/00

(52) U.S. Cl. 707/104.1

(57) ABSTRACT

A method and apparatus for managing content file information based on file paths are provided. The method includes creating a folder table comprising folder paths of content files and folder path identification information corresponding to the folder paths; creating a file table comprising file names of the content files and the folder path identification information corresponding to the content files; and managing the content file information based on information included in the folder table and the file table. The apparatus includes a storage unit which stores at least one content file, a folder table, and a file table; an information input unit which inputs information needed for managing content file information of the at least one content file; and a library module which manages the content file information stored in the storage unit.

### CROSS-REFERENCE TO RELATED APPLICATION

This application claims priority from Korean Patent Application No. 10-2005-0104151, filed on Nov. 2, 2005, in the Korean Intellectual Property Office, the disclosure of which is incorporated herein in its entirety by reference.

### BACKGROUND OF THE INVENTION

1. Field of the Invention

Methods and apparatuses consistent with the present invention relate to managing content file information, and more particularly, to managing content file information based on file paths.

2. Description of the Related Art

Recently, as the use of digital apparatuses such as digital cameras, digital camcorders, and digital audio players has become widely spread, various types of digital content files are being produced. These digital content files include various additional information such as ID3 tags, EXIF tags, and frame rates, in addition to file names as content file information.

Accordingly, since it is required to search for or classify the digital content files by using the above described additional information as well as file names, a related art technique has been suggested to manage the content file information by using a database including hierarchically-defined folders (or directories) wherein the content file information is placed based on the additional information or by using a file-based-database based on a file system.

However, in the related art techniques for managing content file information, the content file information is handled by using a file table and considering the full file path as a basic key. FIG. 1 is a view showing an example of a file table used in related art techniques for managing content file information.

When, for example, 1000 pieces of content file information are included in a database and a user wants to delete or rename one piece of the content file information, according to the related art techniques, the user has to compare the strings of content file information of the content files. Therefore, a long processing time (string comparing time×1000) is necessary to delete or rename one piece of the content file information.

In addition, when a folder including the 1000 pieces of the content file information is subdivided, a sub-folder name is added to the path. Therefore, since the field length necessarily includes the length of the sub-folder path, the field length of the total file path increases. As a result, the processing time is also increased. In case of the Windows Operating System, the maximum length of a file path of a content file is 255 characters.

In addition, when deleting content file information in a folder, since a user has to search for and delete the information of a content file including the folder name for each content file, a processing time as long as (the string comparing time×1000) is necessary.

### SUMMARY OF THE INVENTION

The present invention provides a method, an apparatus, and a recording medium storing a program for managing content file information quickly.

The present invention also provides a method, an apparatus, and a recording medium storing a program capable of reducing the amount of string comparison between content file information pieces by reducing the length of a file path and duplicating usage of the file path.

The present invention also provides a method, and apparatus, and a recording medium storing a program for managing content file information based on file paths by separating folder paths and file names.

The present invention also provides a method, an apparatus, and a recording medium storing a program for managing content file information based on file paths, by using identification information of a folder path as a foreign key.

According to an aspect of the present invention, there is provided a method of managing content file information, the method comprising creating a folder table comprising folder paths of content files and folder path identification information corresponding to the folder paths; creating a file table comprising file names of the content files and the folder path identification information corresponding to the content files; and managing the content file information based on information included in the folder table and the file table.

According to another aspect of the present invention, there is provided an apparatus for managing content file information, the apparatus comprising a storage unit which stores at least one content file, a folder table comprising folder paths of the at least one content files and folder path identification information corresponding to the folder paths, and a file table comprising a file name corresponding to the at least one content file and the folder path identification information corresponding to the at least one content file; an information input unit which inputs information needed for managing content file information of the at least one content file; and a library module which manages the content file information stored in the storage unit and creates and updates the folder table and the file table by using information input from the information input unit and information included in the folder table and the file table.

According to another aspect of the present invention, there is provided a computer-readable recording medium storing a program for performing a method of managing content file information, wherein the method comprises creating a folder table comprising folder paths of content files and folder path identification information corresponding to the folder paths; creating a file table comprising file names of the content files and the folder path identification information corresponding to the content files; and managing the content file information based on information included in the folder table and the file table.

### BRIEF DESCRIPTION OF THE DRAWINGS

The above and other aspects of the present invention will become more apparent by describing in detail certain exemplary embodiments thereof with reference to the attached drawings in which:

FIG. 1 is a view showing an example of a file table based on related art techniques for managing content file information;

FIG. 2 is a functional block diagram showing an apparatus for managing content file information according to an exemplary embodiment of the present invention;

FIG. 3 shows a folder table according to an exemplary embodiment of the present invention;

FIG. 4 shows a file table according to an exemplary embodiment the present invention;

FIG. 5 is a flow chart of a method of managing content file information according to an exemplary embodiment of the present invention;

FIG. 6 is an example of a detailed flow chart of an operation of managing content file information shown in FIG. 5, when registering content file information;

FIG. 7 is another example of a detailed flow chart of the operation of managing content file information shown in FIG. 5, when registering content file information;

FIG. 8 is another example of a detailed flow chart of the operation of managing content file information shown in FIG. 5, when registering content file information;

FIG. 9 is a detailed flow chart of an operation of managing content file information shown in FIG. 5, when searching content file information;

FIG. 10 is a detailed flow chart of an operation of managing content file information shown in FIG. 5, when searching content file information based on folders;.

FIG. 11 is a detailed flow chart of an operation of managing content file information shown in FIG. 5, when deleting a folder;

FIG. 12 is an example of a detailed flow chart of an operation of managing content file information shown in FIG. 5, when deleting content file information;

FIG. 13 is another example of a detailed flow chart of the operation of managing content file information shown in FIG. 5, when deleting content file information;

FIG. 14 is a detailed flow chart of an operation of managing content file information shown in FIG. 5, when renaming a folder; and

FIG. 15 is a detailed flow chart of an operation of managing content file information shown in FIG. 5, when renaming a content file.

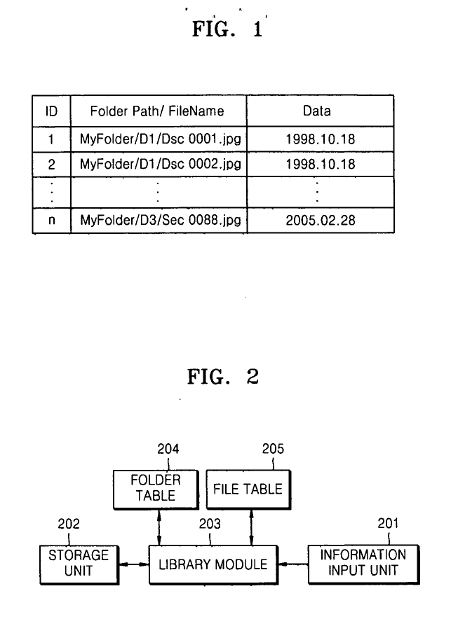

### DETAILED DESCRIPTION OF EXEMPLARY EMBODIMENTS OF THE PRESENT INVENTION

Certain exemplary embodiments of the present invention will now be described in detail with reference to the accompanying drawings.

FIG. 2 is a functional block diagram showing an apparatus for managing content file information according to an exemplary embodiment of the present invention. The apparatus includes an information input unit 201, a storage unit 202, a library module 203, a folder table 204, and a file table 205.

The information input unit 201 inputs information needed for managing the content file information. The managing may include functions of adding, deleting, renaming, and searching for the content file information, or other such functions known in the art. Accordingly, the information input unit 201 can input a command corresponding to a desired function (for example, an adding, deleting, renaming, or searching command). In addition, the information input unit 201 can input the content file information. The content file information may include file names and folder paths of the content files, or other such information. The folder path may be defined as one folder name or a plurality of folder names.

The storage unit 202 may store real data of at least one content file. The content file may include audio, audio and video, video, text content, or a similar type of content that is typically stored.

The library module 203 manages the content file information stored in the storage unit 202 by creating and updating the folder table 204 and the file table 205 by using the information input from the information input unit 201 and the information included in the folder table 204 and the file table 205.

Namely, when the information input unit 201 requests that the content file information stored in the storage unit 202 be registered, the library module 203 adds (or records) the content file information in the folder table 204 and the file table 205 by using the information input from the input unit 201 and the information included in the folder table 204 and the file table 205. Accordingly, the information included in the folder table 204 and the file table 205 is updated.

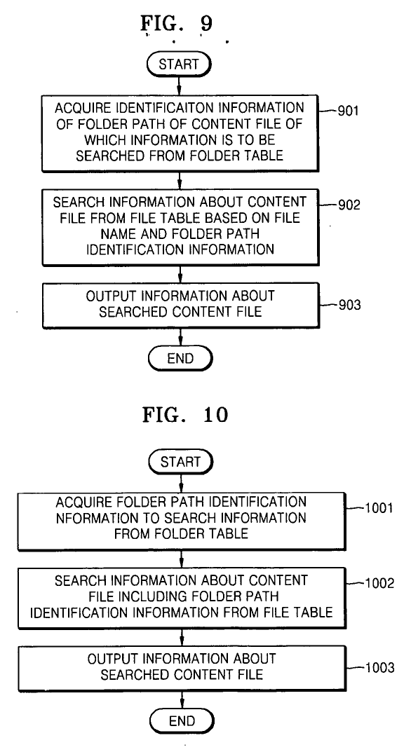

When the information input unit 201 requests that the content file information stored in the storage unit 202 be searched for, as shown in FIG. 9, the library module 203 searches for the content file information by using the information input from the information input unit 201 and the information included in the folder table 204 and the file table 205.

When the information input unit 201 requests that the content file information stored in the storage unit 202 be searched for based on folders, as shown in FIG. 10, the library module 203 searches for the content file information based on folders by using the information input from the information input unit 201 and the information included in the folder table 204 and the file table 205.

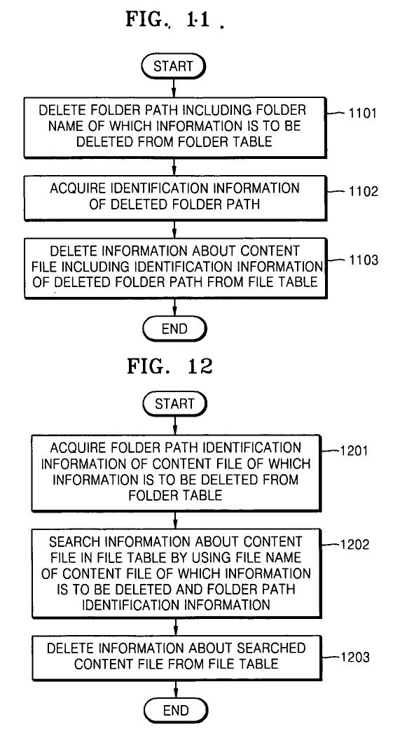

When the information input unit 201 requests that the content file information stored in the storage unit 202 be deleted, as shown in FIGS. 11 and 12, the library module 203 deletes the content file information by using the information input from the information input unit 201 and the information included in the folder table 204 and the file table 205. Accordingly, the information included in the folder table 204, or the folder table 204 and the file table 205, is updated.

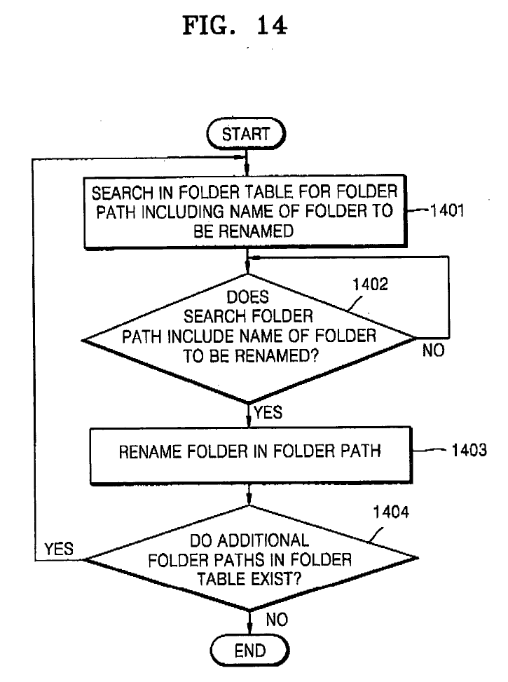

When the information input unit 201 requests that a folder be renamed, as shown in FIG. 14, the library module 203 renames the corresponding folder to a new folder name by using the information input from the information input unit 201 and the information included in the folder table 204. Accordingly, the information included in the folder table 204 is updated.

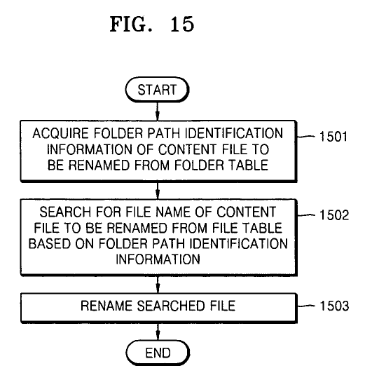

When the information input unit 201 requests that a file be renamed, as shown in FIG. 15, the library module 203 renames the corresponding content file to a new file name by using the information input from the information input unit 201 and the information included in the file table 205. Accordingly, the information included in the file table 205 is updated.

As will be described further below, the library module 203 uses the folder path identification information as a foreign key so as to manage the content file information.

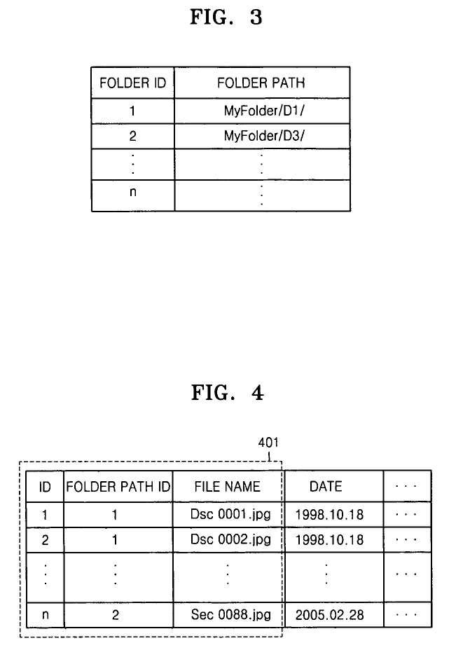

The folder table 204 is created and updated by the library module 203 and includes the folder paths of the content files stored in the storage unit 202 and the folder path identification information. FIG. 3 is a view showing an example of a folder table according to an exemplary embodiment of the present invention. In FIG. 3, the folder path identification information of a folder path “MyFolder/D1/” is “1”, and the folder path identification information of a folder path “MyFolder/D3/” is “2”.

The folder path identification information is allocated according to the order defined in the folder table 204. For example, in a case where n folder paths and n pieces of the folder path identification information are included in the folder table 204, when it is desired to register a new folder path in the folder table 204, the new folder path identification information to be registered is allocated as n+1. When the folder path identification information “2” is deleted, the folder path identification information to be registered may be allocated as “2”. In addition, when pieces of the folder path identification information “2”, “3”, and “5” are deleted, the folder path identification information to be registered may be allocated as the highest ranked piece of information, that is, “2”. This folder path identification information may be allocated by the library module 203 based on the results from monitoring the folder path identification information existing in the folder table 204 by the library module 203.

The file table 205 is created and updated by the library module 203 and includes the additional content file information as well as the folder path identification information of the content file stored and the file name in the storage unit 202. FIG. 4 is a view showing an example of the file table 205 according to an exemplary embodiment of the present invention. Referring to FIG. 4, the folder path identification information of the content file “Dsc0001.jpg” is “1”, and the date of registering the same content file is “1998.10.18”.

Referring to FIGS. 3 and 4, since the folder path identification information of the content file “Dsc0001.jpg” is “1”, the folder path of the content file “Dsc0001.jpg” is “MyFolder/D1/”, based on the folder path identification information “1”. Thus, the library module 203 may identify that the full path of the content file “Dsc0001.jpg” is “MyFolder/D1/Dsc0001.jpg” based on the information included in the folder table 204 and the file table 205.

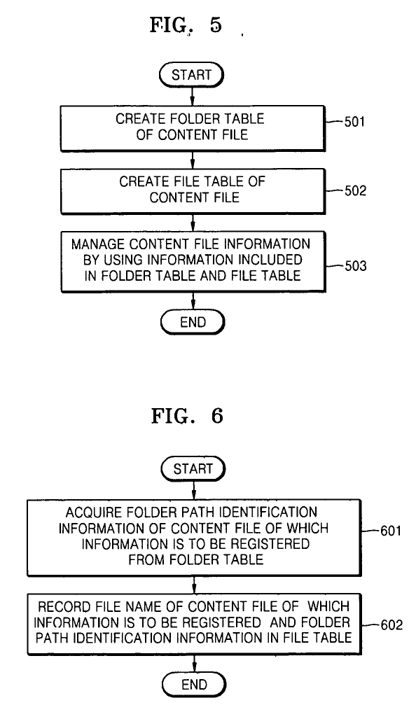

FIG. 5 is a flow chart of a method of managing content file information according to an exemplary embodiment of the present invention. The flow chart of FIG. 5 will be explained in conjunction with FIGS. 2, 3, and 4.

The library module 203 creates the folder table 204 including the folder paths of the content files stored in the storage unit 202 and the folder path identification information with the structure shown in FIG. 3 (operation 501).

In addition, the library module 203 creates the file table 205 including the file names of the content files and the folder path identification information with the structure shown in FIG. 4 (operation 502). It is noted that the storage unit 202 may also include addition information, such as a registration date for the content file. The library module 203 may further include this additional content file information, i.e., the registered date of the content files, in the file table 205.

When the content file is stored in the storage unit 202, the library module 203 can create the folder table 204 and the file table 205 based on the content file information collected by the library module 203 or the information input from the information input unit 201.

When the folder table 204 and the file table 205 are created in this way, the library module 203 manages the content file information by using the information included in the folder table 204 and the file table 205 (503). The library module 203 manages the content file information using the folder path identification information as a foreign key.

FIG. 6 shows a detailed flow chart of the operation 503 executed when registering the content file information, according to an exemplary embodiment of the present invention. FIG. 6 will be explained in conjunction with FIGS. 2, 3, and 4.

The library module 203 acquires the folder path identification information of the content files of which information is to be registered from the folder table 204 (operation 601). The information of the folder paths of the content files may be provided from the information input unit 201. For example, when the folder table 204 is as shown in FIG. 3 and the information of the folder path is “MyFolder/D1/”, the library module 203 acquires “1” as the folder path identification information from the folder table 204.

Then, the acquired folder path identification information and file names of the content files of which information is to be registered are recorded in the file table 205. Namely, when the folder path identification information acquired from the folder table 204 according to the above described example is “1” and the file name of the content file is “Dsc0001.jpg”, the folder path identification information and the file name are recorded in the file table 205 such as “the item of the identification information of the content file (ID) 1” as shown in FIG. 4. Accordingly, the information included in the file table 205 is updated. As shown in FIG. 4, the additional content file information may be also recorded in the file table 205. As shown in FIG. 4, the file table 205 can include the identification information (ID) of the content files, the ID of the folder paths, and the file names as a columm 401 shown in FIG.4.

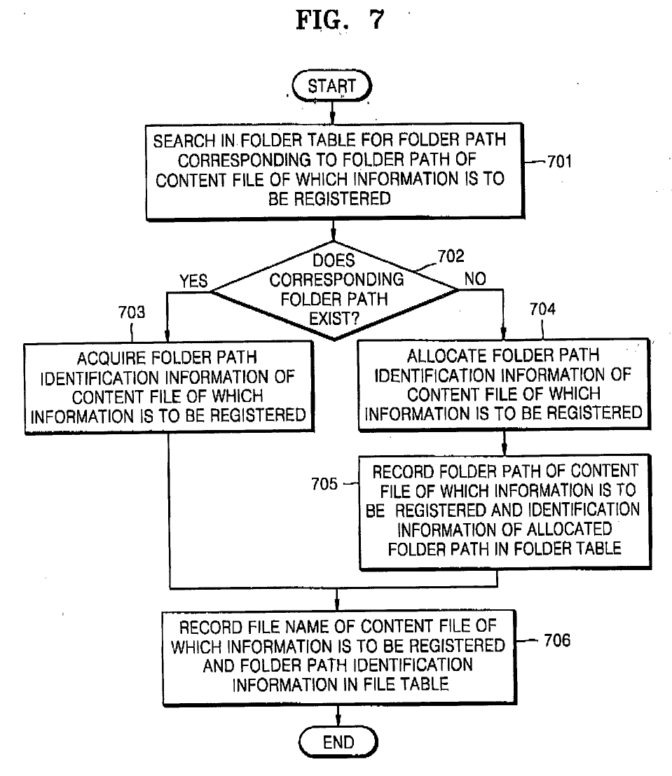

FIG. 7 shows another example of a detailed flow chart of operation 503 (shown in FIG. 3) executed when registering the content file information, according to another exemplary embodiment of the present invention. FIG. 7 will be explained in conjunction with FIG. 2.

The library module 203 searches in the folder table 204 for the folder paths corresponding to the folder paths of the content files of which information is to be registered (operation 701). The information of the folder paths of the content files may be provided from the information input unit 201.

If the folder paths corresponding to the content file of which information is to be registered exist (operation 702), the library module 203 acquires the folder path identification information of the corresponding folder paths stored in the folder table 204 as the folder path identification information of the content files of which information is to be registered (operation 703).

However, when the corresponding folder paths are not found in the folder table 204 (operation 702), the library module 203 allocates the folder path identification information of the content files of which information is to be registered (operation 704). The allocating of the folder path identification information is executed as explained in reference to FIG. 2.

The library module 203 then records the allocated folder path identification information and the folder paths of the content files of which information is to be registered in the folder table 204 (operation 705). Accordingly, the information included in the folder table 204 is updated.

After executing operation 703 or operation 705, the library module 203 records the folder path identification information and the file names of the content files of which information is to be registered in the file table 205. Accordingly, the information included in the file table 205 is updated.

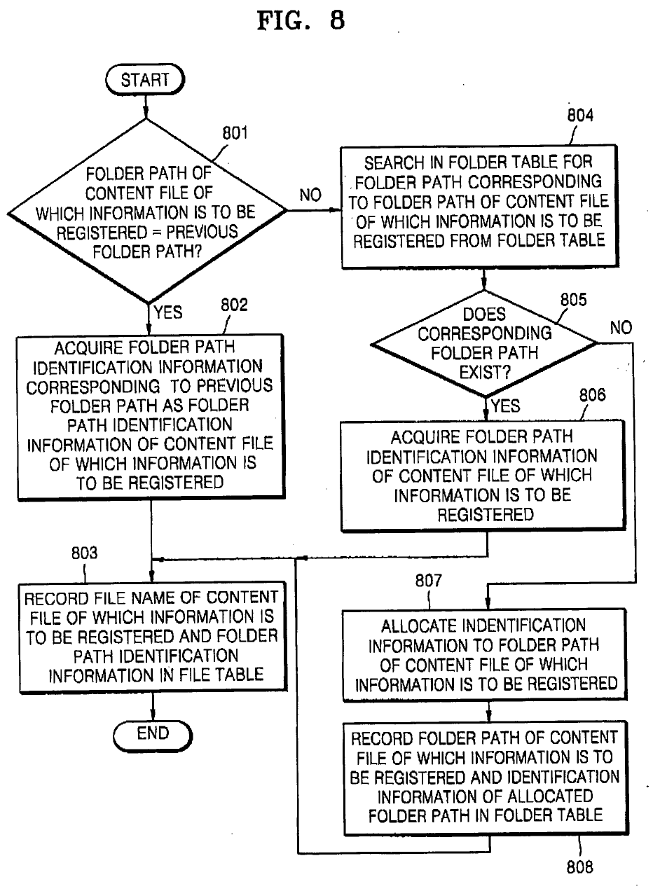

FIG. 8 shows another example of a detailed flow of the operation 503 executed when registering the content file information, according to an exemplary embodiment of the present invention. FIG. 8 will be explained in conjunction with FIG. 2.

The library module 203 compares the folder path of the content file of which information is to be registered with the previous folder path (operation 801). The folder path of the content file of which information is to be registered may be provided from the information input unit 201. The previous folder path may be the folder path used just before by the library module 203 for managing the content file information, and the folder path and the identification information of the corresponding folder path are temporarily held in the library module 203.

When the folder path of the content file of which information is to be registered is identical to the previous folder path, the library module 203 acquires the folder path identification information of the previous folder path as the folder path identification information of the content file of which information is to be registered (operation 802). Namely, when the folder path identification information of the previous folder path is “1”, the identification information of current folder path of the content file of which information is to be registered is set to “1”.

The library module 203 records the acquired folder path identification information and the file name of the content file in the file table 205 (operation 803). Accordingly, the information included in the file table 205 is updated.

On the other hand, when the folder path of the content file of which information is to be registered is not identical to the previous folder path, the library module 203 searches in the folder table 204 for the folder path corresponding to the folder path of the content file of which information is to be registered (operation 804), and a determination is made whether the corresponding folder path exists (operation 805).

When the corresponding folder path exists in the folder table 204, the library module 203 acquires the folder path identification information of the content file of which information is to be registered from the folder table 204 (operation 806), and the library module 203 executes operation 803, which is described above.

When the corresponding folder path does not exist in the folder table 204, the library module 203 allocates the folder path identification information of the content file of which information is to be registered as explained in FIG. 2 (operation 807).

The library module 203 records the allocated folder path identification information and the folder path of the content file of which information is to be registered in the folder table 204 (operation 808). Accordingly, the information included in the folder table 204 is updated. Then, the library module 203 returns to operation 803.

FIG. 9 shows an example of a detailed flow chart of the operation 503 executed when searching for content file information, according to an exemplary embodiment of the present invention. FIG. 9 will be explained in conjunction with FIG. 2.

The library module 203 acquires the folder path identification information of the content files of which information is to be searched from the folder table 204 (operation 901). The information of the folder paths of the content files may be provided from the information input unit 201.

The library module 203 searches for the content file information in the file table 205 by using the acquired folder path identification information and file names of the content files for which information is to be searched (operation 902). The file names of the content files may be provided from the information input unit 201.

When the desired content file information is searched in the file table 205, the library module 203 outputs the found content file information (operation 903). Accordingly, the searched content file information can be provided to a user.

FIG. 10 is an example of a detailed flow chart of the operation 503 executed when searching for content file information based on folders, according to an exemplary embodiment of the present invention. FIG. 10 will be explained in conjunction with FIGS. 2, 3, and 4.

The library module 203 acquires the folder path identification information where the content file information is to be searched for from the folder table 204 (operation 1001). A plurality of pieces of the folder path identification information may be acquired from the folder table 204. When the information of the folder paths where the content file information is to be searched for is one folder name, all the folder paths including the folder name are the folder paths corresponding to the folder paths to be searched for. For example, when the folder path to be searched is for “MyFolder” and the folder table is as shown in FIG. 3, the library module 203 acquires the identification information “1” and “2” from the folder table 204. The information of the folder path to be searched for can be input from the information input unit 201.

When the folder path identification information is acquired from the folder table 204, the library module 203 searches for the content file information including the folder path identification information in the file table 205 based on the acquired folder path identification information (operation 1002). For example, when the acquired folder path identification information is “1” and the file table 205 is as shown in FIG. 4, pieces of the information of the file “Dsc0001.jpg” and the file “Dsc0002.jpg” are searched for in operation 1002.

Thus, when a plurality of pieces of folder path identification information are acquired as described in the above examples, all the pieces of the content file information including a plurality of pieces of the acquired folder path identification information are searched for in the file table 205. Namely, all the pieces of the content file information to which pieces of the folder path identification information “1” and “2” are allocated are searched for.

The library module 203 outputs the searched content file information (operation 1003). Accordingly, the searched content file information can be provided to a user.

FIG. 11 shows a detailed flow chart of the operation 503 shown in FIG. 5, executed when deleting a folder, according to an exemplary embodiment of the present invention. FIG. 11 will be explained in conjunction with FIGS. 2 and 3.

The library module 203 deletes the folder paths including the folder name to be deleted from the folder table 204 (operation 1 101). For example, when the folder name to be deleted is “MyFolder”, the folder paths of which pieces of the identification information are “1” and “2” are deleted from the folder table 204 shown in FIG. 3. The information about the folder name to be deleted can be provided from the information input unit 201.

The library module 203 acquires the identification information of the deleted folder paths while deleting the folder paths including the folder name to be deleted from the folder table 204 (operation 1 102). The library module 203 acquires “1” and “2” as the identification information of the deleted folder paths in operation 1102, according to the above described example.

The library module 203 deletes the content file information including the identification information of the deleted folder paths from the file table 205 (operation 1103). As in the above described example, when the pieces of the folder path identification information “1” and “2” are acquired, the pieces of the content file information of which the pieces of the identification information are “1”, “2”, and “n” are deleted from the file table 205. The folder path identification information of the content files of which the pieces of the identification information are “1”, “2”, and “n” is “1” or “2”.

FIG. 12 shows a detailed flow chart of the operation 503 shown in FIG. 5, executed when deleting content file information, according to an exemplary embodiment of the present invention. FIG. 12 will be explained in conjunction with FIG. 2.

The library module 203 acquires the folder path identification information of the content file of which information is to be deleted from the folder table 204 (operation 1201). The information of the folder paths of the content file of which information is to be deleted may be provided from the information input unit 201.

The library module 203 searches for the content file information in the file table 205 by using the acquired folder path identification information and the file name of the content file of which information is to be deleted (operation 1202). The file name of the content file of which information is to be deleted may be provided from the information input unit 201.

The library module 203 deletes the searched content file information from the file table 205 (operation 1203).

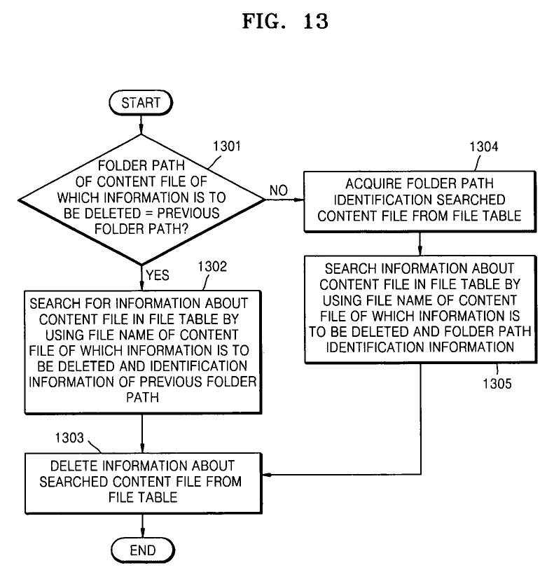

FIG. 13 is another example of a detailed flow chart of the operation 503 shown in FIG. 5, executed when deleting content file information, according to an exemplary embodiment of the present invention. FIG. 13 will be explained in conjunction with FIG. 2.

The library module 203 compares the folder paths of the content file of which information is to be deleted with the previous folder path to determine whether the folder part of the content file of which information is to be deleted is the same as a previous folder path (operation 1301). The information of the folder paths of the content file of which information is to be deleted may be provided from the information input unit 201. The previous folder path is the folder path used just before by the library module 203 for managing the content file information, and this folder path and the identification information of the corresponding folder path are temporarily held in the library module 203.

When the folder path of the content file of which information is to be deleted is identical to the previous folder path, the library module 203 searches for the content file information from the file table 205 by using the identification information of the previous folder path and the file name of the content file of which information is to be deleted (operation 1302).

When the content file information is searched for in the file table, the library module 203 deletes the searched information of the content file from the file table 205 (operation 1303).

However, when the folder path of the content file of which information is to be deleted is not identical to the previous folder path, the library module 203 performs identical operations to operation 1201 and operation 1202, described above (operation 1304 and operation 1305), and operation 1303 is performed (also identical to operation 1203 discussed above).

FIG. 14 shows a detailed flow chart of the operation 503 shown in FIG. 5, executed when renaming a folder, according to an exemplary embodiment of the present invention. FIG. 14 will be explained in conjunction with FIG. 2.

The library module 203 searches in the folder table 204 for the folder paths including the name of the folder to be renamed (operation 1401). For example, when it is desired to rename the folder “MyFolder” to “MyContents”, the library module 203 searches in the folder table 204 for the folder paths including the folder name “MyFolder”. The name of the folder to be renamed may be provided from the information input unit 201. When the folder paths including the name of the folder to be renamed are found (operation 1402), the library module 203 renames the corresponding folder in the identified folder paths (operation 1403). For example, when the folder path “MyFolder/D1/” is encountered, the found folder path is renamed to “MyContents/D1/”. A determination is then made if additional folder paths exist in the folder table that still need to be searched (operation 1404). If additional folder paths exist, then operation passed back to operation 1401.

When the name of the folder to be renamed is not found (operation 1402), the operation of the library module 203 proceeds back to operation 1401 in order to evaluate the next folder path, and the library module 203 performs the above described operations 1401 and 1402 repeatedly. For example, when in operation 1403 the folder path identification information “1” is searched for, the folder paths not searched for are the folder paths corresponding to the folder path identification information “2 to n”.

Referring to FIG. 14, the folder paths including the folder name “MyFolder” are searched for among the folder paths stored in the folder table 204, and the folder name “MyFolder” included in the searched folder path is renamed to “MyContents”. Accordingly, the folder table 204 is updated to include the renamed folder.

FIG. 15 shows a detailed flow of the operation 503 shown in FIG. 5, executed when renaming a content file, according to an exemplary embodiment of the present invention. FIG. 15 will be explained in conjunction with FIG. 2.

The library module 203 acquires the folder path identification information of the content file to be renamed from the folder table 204 (operation 1501). The information of the folder paths of the renamed content file may be provided from the information input unit 201.

The library module 203 searches in the file table 205 for the file name of the content file to be renamed based on the folder path identification information (operation 1502). Thereafter, the library module 203 renames the found file (operation 1503). Accordingly, the file table 205 is updated so as to include the renamed file name.

The present inventive concept can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

As described above, according to exemplary embodiments of the present invention, it is possible to increase a processing speed of adding, deleting, renaming and searching for information of a content file by reducing the amount of the string comparison between the content file information pieces, by reducing the length of a file path and by reducing the duplicating usage of the file path, when the library module manages the content file information by managing a folder table based on a folder path of a content file and folder path identification information and a file table based on folder path identification information of a content file and a file name individually.

While the present invention has been particularly shown and described with reference to certain exemplary embodiments thereof, it will be understood by those skilled in the art that various changes in form and details may be made therein without departing from the spirit and scope of the invention as defined by the appended claims. The exemplary embodiments should be considered in a descriptive sense only and not for purposes of limitation. Therefore, the scope of the invention is defined not by the detailed description of the invention but by the appended claims, and all differences within the scope will be construed as being included in the present invention.

What is claimed is:

1. A method of managing content file information, the method comprising:
creating a folder table comprising folder paths of content files and folder path identification information corresponding to the folder paths;
creating a file table comprising file names of the content files and the folder path identification information corresponding to the content files; and
managing the content file information based on information included in the folder table and the file table.

2. The method of claim 1, wherein, in the managing of the content file information, the content file information is managed by using the folder path identification information as a foreign key.

3. The method of claim 1, wherein the file table further comprises additional information corresponding to each of the content files.

4. The method of claim 1, wherein the managing of the content file information comprises:
acquiring, from the folder table, the folder path identification information corresponding to a content file whose information is to be registered; and
recording, in the file table, the acquired folder path identification information and the file name of the content file whose information is to be registered.

5. The method of claim 4, wherein the managing of the content file information further comprises:
comparing a folder path of the content file whose information is to be registered with existing folder paths;
acquiring, from the folder table, the folder path identification information corresponding to one of the existing folder paths as the folder path identification information of the content file whose information is to be registered, if the folder path of the content file whose information is to be registered is the same as the one of the existing folder paths; and
acquiring, from the folder table, the folder path identification information, if the folder path of the content file whose information is to be registered is not the same as the any of the existing folder paths.

6. The method of claim 5, wherein the managing of the content file information further comprises:
allocating the folder path identification information of the content file whose information is to be registered based on the folder path identification information already included in the folder table if a folder path corresponding to the folder path of the content file whose information is to be registered does not exist in the folder table; and
recording the folder path of the content file whose information is to be registered and the allocated folder path identification information in the folder table.

7. The method of claim 4, wherein the managing of the content file information further comprises:
allocating the folder path identification information of the content file whose information is to be registered based on the folder path identification information already included in the folder table if a folder path corresponding to the folder path of the content file whose information is to be registered does not exist in the folder table; and
recording the folder path of the content file whose information is to be registered and the allocated folder path identification information in the folder table.

8. The method of claim 1, wherein the managing of the content file information comprises:
acquiring, from the folder table, the folder path identification information of a content file whose information is to be searched for;
searching the content file information in the file table using the file name of the content file whose information is to be searched for and the acquired folder path identification information; and
outputting a result of the searching.

9. The method of claim 1, wherein the managing of the content file information comprises:
acquiring, from the folder table, the folder path identification information whose information is to be searched for;
searching in the file table for at least one content file information corresponding to the acquired folder path identification information; and
outputting a result of the searching.

10. The method of claim 1, wherein the managing of the content file information comprises:
deleting from the folder paths included in the folder table, a folder path corresponding to a folder name to be deleted;
acquiring the folder path identification information of the deleted folder path; and
deleting from the file table the content file information corresponding to the acquired folder path identification information.

11. The method of claim 1, wherein the managing of the content file information comprises:
acquiring, from the folder table, folder path identification information corresponding to a content file whose information is to be deleted;
searching the file table for the content file information which is to be deleted from the file table based on the file name of the content file whose information is to be deleted and the acquired folder path identification information; and
deleting from the file table the content file information which is a result of the searching.

12. The method of claim 11, wherein the managing of the content file information comprises:
comparing the folder path corresponding to the content file whose information is to be deleted with a previous folder path;
searching the file table for the content file information which is to be deleted from the file table by using the folder path identification information of the previous folder path and the file name of the content file whose information is to be deleted, if the folder path of the content file whose information is to be deleted is the same as the previous folder path; and
acquiring, from the folder table, the folder path identification information corresponding to the folder path of the content file whose information is to be deleted, if the folder path of the content file whose information is to be deleted is not the same as the previous folder path.

13. The method of claim 1, wherein, the managing of the content file information comprises:
searching in the folder table for folder paths corresponding to a folder to be renamed; and
renaming the folder paths identified as a result of the searching a new folder name.

14. The method of claim 1, wherein the managing of the content file information comprises:
acquiring, from the folder table, folder path identification information corresponding to a content file to be renamed;
searching the file table for a file name of the content file to be renamed based on the acquired folder path identification information; and
renaming the file name found as a result of the searching a new file name.

15. An apparatus for managing content file information, the apparatus comprising:
a storage unit which stores at least one content file, a folder table comprising folder paths of the at least one content files and folder path identification information corresponding to the folder paths, and a file table comprising a file name corresponding to the at least one content file and the folder path identification information corresponding to the at least one content file;
an information input unit which inputs information needed for managing content file information of the at least one content file; and
a library module which manages the content file information stored in the storage unit and creates and updates the folder table and the file table by using information input from the information input unit and information included in the folder table and the file table.

16. The apparatus for managing content file information of claim 15, wherein the library module manages the content file information included in the folder table and the file table based on the folder path identification information as a foreign key.

17. The apparatus for managing content file information of claim 15, wherein the file table further comprises additional content file information corresponding to the at least one content file.

18. A computer-readable recording medium storing a program for performing a method of managing content file information, wherein the method comprises:
creating a folder table comprising folder paths of content files and folder path identification information corresponding to the folder paths;
creating a file table comprising file names of the content files and the folder path identification information corresponding to the content files; and
managing the content file information based on information included in the folder table and the file table.
